(19) United States
(12) Patent Application Publication
(10) Pub. No.: US 2018/0299249 A1
(43) Pub. Date: Oct. 18, 2018

(54) HIGH-RESOLUTION DISTANCE MEASUREMENT BY MEANS OF INTERFEROMETRY

(71) Applicant: LEICA GEOSYSTEMS AG, Heerbrugg (CH)

(72) Inventor: Konrad WILDI, Unterentfelden (CH)

(73) Assignee: LEICA GEOSYSTEMS AG, Heerbrugg (CH)

(21) Appl. No.: 15/953,103

(22) Filed: Apr. 13, 2018

(30) Foreign Application Priority Data
Apr. 13, 2017 (EP) 17166662.1

(51) Int. Cl. G01B 9/02; G01S 17/32

(52) U.S. Cl. CPC G01B 9/02002; G01S 17/325

(57) ABSTRACT

A method and a measuring appliance for measuring a distance by means of interferometry, by means of a measurement radiation and a reference radiation that is frequency-shifted relative thereto, produced by a frequency shifter that is actuated by a carrier signal, wherein, within the scope of deriving the distance measurement, a system clock is decoupled from a reference counter for capturing a carrier frequency of the carrier signal and care is taken that the system clock and the reference clock are as different as possible in order to obtain phase information and thereby achieve an improvement in the resolution.

The invention relates to a method for determining the distance to a retroreflective target according to the preamble of Claim 1 and to a measuring appliance for carrying out the method according to the invention according to Claim 8.

Rangefinders, as are used in laser trackers for industrial measurements, for example, or in geodesic measuring appliances—e.g. theodolites or total stations—are often embodied as interferometers or have a combination with an interferometric unit, for example a combination of a distance measurement according to the pulse time-of-flight principle with an interferometric measurement.

A very high accuracy can be obtained by using an interferometric measurement method. Here, the achievable resolution for the distance measurement using the interferometer (e.g. the distance measurement accuracy that is achievable on the basis of counting transitions between constructive and destructive interference) is defined by the wavelength of the emitted laser light. Accordingly, the achievable resolution is typically specified substantially as an integer multiple of half the wavelength of the measurement radiation as the laser light has to travel the same path twice on its way to the target and back.

A target point for an interferometric measuring appliance, for example a laser tracker for continuously tracking a target point and a coordinate position determination of this point, can be represented by a retroreflective unit (e.g. a cube prism) which is targeted by an optical measurement beam of the measuring apparatus, in particular a laser beam. The laser beam is reflected back to the measuring appliance in parallel, with the reflected beam being captured by a capturing unit of the apparatus. In the example of the laser tracker, an emission or reception direction of the beam is ascertained in the process, for example by means of sensors for an angle measurement which are assigned to a deflection mirror or a targeting unit of the system. Moreover, a distance from the measuring appliance to the target is ascertained when capturing the beam, for example by means of a time-of-flight or phase difference measurement.

On account of great coherence length and measurement range facilitated thereby, gas lasers, for example HeNe lasers, are often used as a light source for the interferometer. Alternatively, diode lasers are also increasingly used these days, said diode lasers being compact and cost effective per se and having a lower power consumption in comparison with the gas lasers.

A stabilization to a known wavelength is often additionally required, particularly for the use of laser diodes as interferometer light source or as a wavelength standard. By way of example, this can be effectuated in spectroscopic fashion on an absorption line of an absorption medium (e.g. using a gas cell).

The prior art has disclosed different interferometric measurement methods, for example various relatively simple measurement arrangements for measuring relative changes in distance and complex arrangements for measuring absolute distances by means of interferometric measurements, or a combination of relative interferometric distance measurements with a so-called absolute rangefinder.

By way of example, a combination of measurement means for determining the distance is known from the product AT901 by Leica Geosystems AG. A combination of an absolute rangefinder and an interferometer for determining the distance using a HeNe laser is known from WO 2007/079600 A1, for example.

According to the basic interferometric measurement principle—counting wavelength increments, for example by means of transitions from constructive to destructive interference—interferometers measure relative changes in distance, with it often not being possible to distinguish whether a target object moves away from the measuring instrument or whether the target object moves towards the measuring instrument.

An option for deriving a directional information item (information as to whether the distance to the target increases or reduces) consists of, for example, overlaying a frequency-shifted reference radiation on the measurement radiation that was emitted and reflected at the target for the purposes of ascertaining an interferometric output signal, wherein the directional information item can then be ascertained with the aid of the Doppler effect, for example.

In order to carry out the correct measurement of the change in distance, in particular a continuous correct measurement when tracking a target, by means of the interferometer, a continuous capture and correct readout of the interferometer signals produced by the interference effects (e.g. intensity maxima and minima) must be ensured during the measurement. Here, determining the change in the distance depends on the number of detected interferometer signals (wavelength increments).

In particular, conventional interferometers according to the prior art are limited, in principle, inasmuch as the resolution for the distance measurement is restricted to a wavelength increment that is substantially given by half the wavelength of the measurement radiation since the counter of the wavelength increment from an interferometer output signal can only derive whole 360 degree phase shifts and inasmuch as no phase information can be derived in the case of the target at rest.

It is therefore an object of the invention to provide a method for a distance measuring appliance, within the scope of which the distance resolution of an interferometric measurement is increased, in particular wherein distance measurements can be carried out with a greater accuracy than half the wavelength of the emitted radiation.

This object is achieved by the implementation of the characterizing features of the independent claims. Features which develop the invention in an alternative or advantageous manner can be gathered from the dependent patent claims.

The invention relates to a method for determining a change in the distance to a retroreflective target by means of interferometry, including producing radiation at a defined frequency, wherein at least some of the radiation is used as reference radiation and at least some of the radiation is emitted toward the target as measurement radiation, and shifting the frequency of some of at least one of the measurement radiation, the reference radiation and a reception radiation, which is based at least on some of the measurement radiation returning from the target. The frequency shift is produced by means of a frequency shifter, actuated by a carrier signal, for example an acousto-optic modulator, wherein the carrier signal has a carrier frequency. The invention further includes capturing a superposition signal on the basis of at least some of the reception radiation and the reference radiation, for example by detecting and optionally electronically further processing an optical superposition of the reception radiation with the reference radiation by way of a light-sensitive detector, for example on the basis of a photodiode. On the basis of the superposition signal, an interferometer output signal with an interferometer output frequency, specified IFM frequency below, is produced, wherein the change in distance is derived on the basis of the IFM frequency and the carrier frequency, in particular on the basis of the Doppler effect, namely on the basis of discrete positive and negative values of a wavelength increment which is substantially provided as an integer multiple of half the wavelength of the measurement radiation. Here, the IFM frequency is captured by reception counts of a reception counter, the carrier frequency is captured by reference counts of a reference counter, and the reception counts and the reference counts are transferred by means of a synchronization member based on a system clock with a system frequency into a common system counting system such that, on the basis of system counts of the system counting system, it is possible to derive a current change in distance to the target.

According to the present invention, the system frequency differs from the carrier frequency by a defined difference frequency, and the change in distance is derived taking account of a counter history of the system counting system over a count range defined over a plurality of clock pulses of the system counting system, for example by integrating the counter history over the defined count range.

In one embodiment, the system frequency is greater than 50 MHz, for example, in particular greater than 100 MHz, specifically greater than 200 MHz. Here, the system frequency can be greater or less than the carrier frequency.

By way of example, counters based on a Gray code counter, in particular a Johnson counter, can be used as a reception counter and/or a reference counter.

By way of example—since the two input signals (carrier signal and superposition signal) typically are asynchronous and have a similar frequency to the system frequency—the input signals are controlled by two Johnson counters and not sampled directly. Johnson counters have similar properties to Gray code counters, but have the advantage that the individual bit frequencies are lower, as a result of which long metastable states are also captured and do not lead to permanent errors in the subsequent signal chain. In this case, the bit width of the two counters emerges from e.g. the maximum counts to be counted between two system clock flanks, the capturing of metastable states and the desired safety margin.

By way of example, the two current counts are now transferred via a synchronization member into a common system counting system with the clock pulse of the system clock, wherein the two respectively current counts are subtracted from the previous counts with the clock pulse of the system clock. These differences state by how many “counts” the two input signals have incremented their respective counters during the last system clock phase. Since the two input clock frequencies are e.g. lower than the system frequency of the system clock, the emerging differences can only assume the values of 1 and 0. With the clock pulse of the system clock, these two differences are now subtracted from one another and the result, which can assume the values of −1, 0 and 1, is added to a summing member. The summing member thus contains a snapshot of the interferometer distance, typically in the number of half wavelengths since the start of the measurement.

By way of example, the reference counter, the reception counter, the system counting system and the synchronization member can be embodied in such a way that a repetition rate of the system is defined in such a way that the sampling of the carrier signal is effectuated periodically at exactly the same location again with a defined number of clock pulses of the system clock.

In the aforementioned exemplary system, the current value of the summing member is added to an integrator and a modulo counter is increased by one with each clock pulse of the system clock. Once the modulo counter reaches its modulo value, which corresponds to the repetition rate of the exemplary system, the value of the integrator is written into a readout register and the content of the integrator is subsequently deleted. The content of the readout register thus contains modulo-times the actual value.

Alternatively, it is also possible, for example, to form a moving average over n-times the modulo value such that, for example, a new result is available with each clock pulse of the system clock.

Thus, in order to obtain an improvement in the resolution and a phase information item, the system clock is decoupled from the reference clock for the reference counter (and the reception clock for the reception counter), for example, according to the present invention and care is taken that the system clock and the reference clock are as different as possible, wherein the adding member has an integrator attached thereto. By way of example, the frequency of the reference clock can be generated by means of a phase-locked loop, for example by means of a phase-locked loop (PLL) contained in an FPGA (field programmable gate array). This allows at least a restricted independence from the system clock.

A further resolution improvement can moreover be produced by virtue of the reference clock and the system clock optionally being subjected to jitter.

In one embodiment, the reference counter, the reception counter, the system counting system and the synchronization member are configured, for example, in such a way that the count range is defined as a periodic count range, as a result of which, for example, the repetition rate of the system is defined, namely in such a way that the carrier signal is respectively sampled periodically at the same location again with a number of clock pulses of the count range.

A further embodiment relates to the derivation of the change in distance being effectuated periodically with a period equaling the number of clock pulses of the count range, or the derivation of the change in distance being effectuated in a moving manner, in particular by means of a moving mean on the basis of a continuous integration of the system counts.

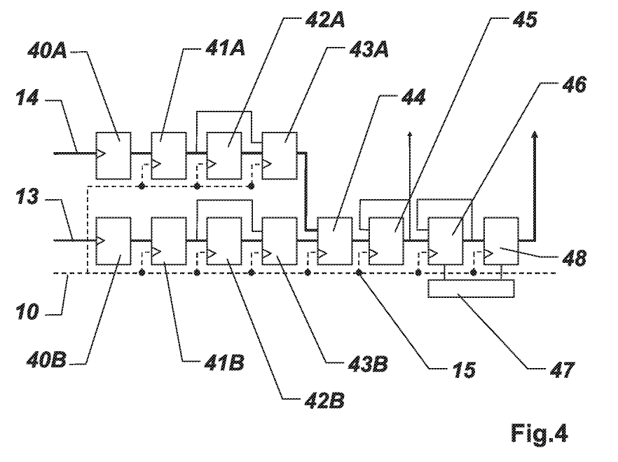

By way of example, let the system frequency be 100 MHz and the carrier frequency derived therefrom for an acousto-optic modulator (AOM) be 100 MHz×31/52=59.615 MHz (on the basis of a 32-bit summing member, 4-bit subtraction member and a 48-bit integrator; see e.g. the embodiment in FIG. 4), wherein the sampling of the carrier signal is effectuated at exactly the same location again after 52 clock pulses of the system clock. Therefore, the resolution of this system is given by 1/52×½ of the wavelength of the measurement radiation.

A further embodiment relates to an integration of the counter history of the system counting system being effectuated by means of an integration process that is automated over several clock pulses of the system counting system, wherein the integration process includes the following steps: producing a reception difference by forming the difference between two reception counts, in particular between two reception counts immediately in succession; producing a reference difference by forming the difference between two reference counts, in particular between two reference counts immediately in succession; producing a summand for the addition in a summing member, wherein the summand is produced by forming a difference between the reception difference and the reference difference; and integrating the counter history by means of an integrator on the basis of the summand. By way of example, in this case the integration is effectuated periodically in each case over the number of clock pulses of the periodic count range.

According to further embodiment of the invention, the carrier signal has a defined jitter of the carrier frequency and/or a defined jitter of the system frequency is produced, for example by subjecting the system clock to jitter. By way of example, the carrier signal and/or the system frequency are configured in such a way that they have a minimal period jitter of 1/(2×fₛ×n_{mod}), where fₛ is the system frequency and n_{mod} is the number of clock pulses of the periodic count range.

Here, care should be taken that, for example, the modulation signal is respectively provided by white noise or a triangle-like signal for whitening the reference clock and/or the system clock noise, the peak amplitude of the said triangle-like signal according to the aforementioned example causing e.g. a minimal period jitter of ±1/(2×100 MHz×52)=±100 ps.

The invention further relates to a measuring appliance for determining the change in distance to a retroreflective target by means of interferometry, comprising a radiation source for producing radiation with a defined wavelength, a reference channel and a measurement channel which are configured such that at least some of the radiation produced by the radiation source can be used as a reference radiation via the reference channel and at least some of the radiation produced by the radiation source can be emitted as a measurement radiation to the target via the measurement channel. The measuring appliance further has a frequency shifter that is actuatable by a carrier signal, in particular an acousto-optic modulator, which is configured to produce a frequency shift of part of at least one of the measurement radiation, the reference radiation and a reception radiation based at least in part on the measurement radiation returning from the target, on the basis of the carrier frequency of the carrier signal. The measuring appliance further has a receiver, for example a fight-sensitive detector on the basis of a photodiode with corresponding signal processing electronics, said receiver being configured to capture a superposition signal on the basis of at least some of the reception radiation and the reference radiation, and to provide an interferometer output signal with an interferometer output frequency, referred to as IFM frequency below, on the basis of the superposition signal. The measuring appliance moreover has a circuit having a reception counter configured to capture the IFM frequency by reception counts, a reference counter configured to capture the carrier frequency by reference counts, a system counting system based on a system clock having a system frequent configured to provide a common counting system, and a synchronization member configured to transfer the reception counts and the reference counts into the common system counting system. By means of a computing unit configured to derive the change in distance on the basis of the IFM frequency and the carrier frequency, in particular on the basis of the Doppler effect, to be precise on the basis of discrete positive and negative values of a wavelength increment which is substantially provided as an integer multiple of half the wavelength of the measurement radiation, a current change in distance to the target is derived on the basis of system counts of the system counting system.

According to the present invention, the measuring appliance is moreover configured in such a way that the system frequency differs from the carrier frequency by a defined difference frequency and a counter history of the system counting system is provided over a count range that is defined over several clock pulses of the system counting system, wherein the computing unit is configured such that the derivation of the change in distance is carried out taking account of the counter history. By way of example, the circuit further has an integrator for integrating the counter history over the defined count range.

By way of example, the system frequency may be greater than 50 MHz in one embodiment, in particular greater than 100 MHz, specifically greater than 200 MHz. In general, the system frequency may be greater than or less than the carrier frequency in this case.

By way of example, counters based on a Gray code counter, in particular a Johnson counter, can be used as a reception counter and/or reference counter.

Thus, according to the present invention, the system clock is decoupled from the reference clock of the reference counter (and/or the reception clock of the reception counter), for example, and care is taken that the system clock and the reference clock are as different as possible.

In one embodiment of the measuring appliance, the reference counter, the reception counter, the system counting system and the synchronization member are configured in such a way that the count range is defined as a periodic count range, as a result of which e.g. a repetition rate of the system is defined, namely in such a way that the carrier signal is respectively sampled periodically at the same point again with a number of clock pulses of the count range.

A further embodiment relates to the circuit and the computing unit being configured in such a way that the change in distance is derived periodically with a period equal to the number of clock pulses of the count range or the change in distance is derived in a moving manner, in particular by means of a moving mean on the basis of a continuous integration of the system counts by means of an integrator.

According to a further embodiment, the circuit has an integrator and it is configured in such a way that an integration of the count history of the system counting system is effectuated by means of an integration process that is automated over several clock pulses of the system counting system, wherein the integration process includes the following steps: producing a reception difference by forming the difference between two reception counts, in particular between two reception counts immediately in succession; producing a reference difference by forming the difference between two reference counts, in particular between two reference counts immediately in succession; producing a summand for the addition in a summand, wherein the summand is produced by forming a difference between the reception difference and the reference difference; and integrating the counter history by means of the integrator on the basis of the summand. By way of example, the integration can be effectuated periodically here, in each case over the number of clock pulses of the periodic count range.

By way of example, for the purposes of further improving the resolution, the carrier signal can be configured in such a way, for example, that the carrier signal has a defined jitter of the carrier frequency, for example wherein the reference clock of the carrier signal is subjected to a jitter, and/or the circuit can be configured, for example, such that a defined jitter of the system frequency is produced, for example by subjecting the system clock to a jitter. By way of example, subjecting to a jitter can be effectuated in such a way that the carrier frequency and/or the system frequency have a minimal period jitter of 1/(2×fₛ×n_{mod}), where fₛ is the system frequency and n_{mod} is the number of clock pulses of the periodic count range.

The distance measurement method according to the invention and the distance measuring appliance according to the invention are described in more detail below in a purely exemplary manner on the basis of exemplary embodiments that are illustrated schematically in the drawings. In the figures, the same elements are denoted by the same reference sign. The described embodiments are not, as a rule, illustrated true-to-scale and should not be understood to be a limitation either.

In detail:

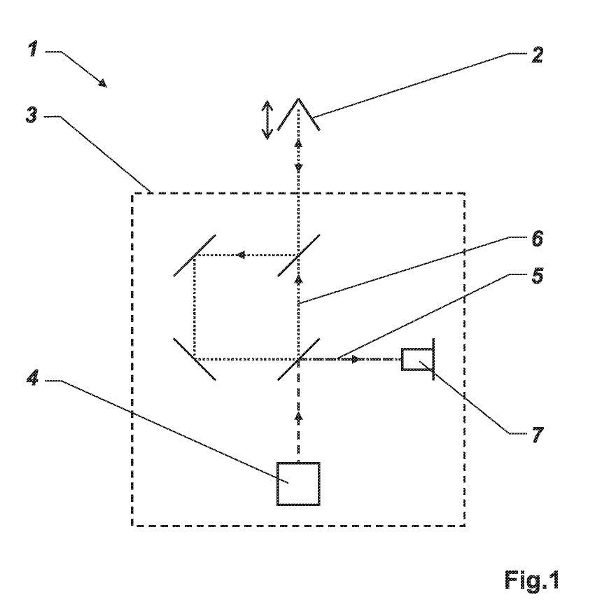

FIG. 1 shows an illustration of the principle of a (homodyne) interferometer arrangement;

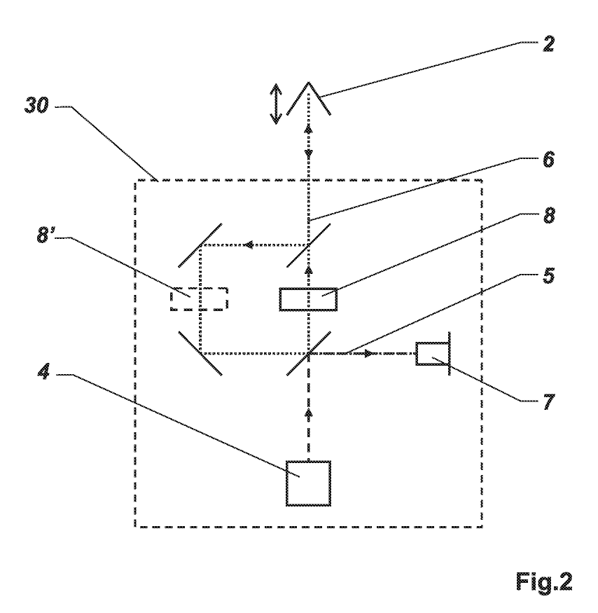

FIG. 2 shows an illustration of the principle of a heterodyne interferometer arrangement according to the present invention;

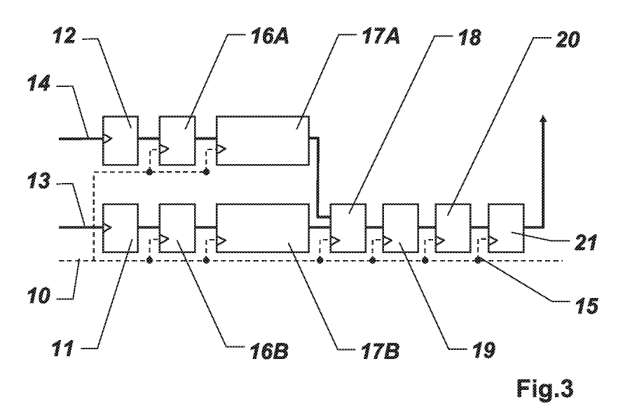

FIG. 3 shows an illustration of the principle of the derivation of a change in distance according to the invention; and

FIG. 4 shows an exemplary embodiment of a circuit according to the invention for deriving a change in distance.

FIG. 1 shows the basic design of an exemplary interferometer arrangement 1 having a target 2 for a measuring appliance 3, in particular for a laser tracker. The beam source 4 which is embodied as a laser diode or a gas laser source with a large coherence length in each case, for example, is used to produce a measurement radiation which is guided firstly to a reference path 5 as reference radiation and secondly to a transmission path 6 as transmission radiation by means of beam splitters. The transmission radiation is directed onto the retroreflective target 2 and reflected back to the interferometer construction 3 therefrom. Here, a change in distance to the interferometer is determinable and measurable by means of the interferometer receiver 7. To this end, the reference radiation and the parts of the transmission radiation returning from the target 2 are superimposed on the interferometer receiver 7, as a result of which these beams interfere and produce an interference profile as an output variable profile in a temporally resolved manner, said output variable profile being readable by means of the interferometer receiver 7.

If there is a movement of the target 2 relative to the interferometer arrangement of the measuring appliance 3 in such a way that there is a change at least in the distance between the target 2 and the construction 3, a change in the interference profile (output variable profile) can be captured by means of the interferometer receiver 7. By way of example, an alternating sequence of intensity maxima and intensity minima produced by the interference can be detected in this case. In this context, it is possible to read-out and continuously count so-called interferometer pulses (wavelength increments), e.g. captured maxima and/or minima, such that a change in distance between target 2 and interferometer construction 3 can be determined from a determined number of pulses. Here, the maximum achievable distance resolution is substantially limited by half the wavelength of the transmission radiation since the transmission radiation must travel along the same path twice when traveling to the target 2 and back.

Such an embodiment can be considered to be a (classical) homodyne interferometer. In a specific embodiment, the change in distance can be determined to this end, for example by means of quadrature detection.

FIG. 2 shows an embodiment of a measuring appliance 30 according to the invention as a heterodyne interferometer (e.g. a heterodyne Michelson interferometer). Here, radiations which differ slightly in respect of the wavelength by way of a difference wavelength are respectively used in the two arms of the interferometer (transmission path 6 and reference path 5), said radiations being produced by an acousto-optic modulator 8, for example,that is actuated by a carrier signal (with a carrier frequency) and arranged like in this case in the transmission path for example. Alternatively, an arrangement of a single acousto-optic modulator 8′ in the reception path or in the reference path 5 (not shown) or a combination of a plurality of differently arranged modulators in the transmission path, reception path and/or reference path (not shown) is also possible.

For the purposes of producing the radiations with different wavelengths (frequency shifts), use can be made of, for example, lasers that use the Zeeman effect (e.g. multi-frequency lasers) or acousto-optic modulators, like in the example shown.

By way of example, the modulator produces a transmission radiation with a first wavelength (or first frequency) and a reference radiation with a second wavelength (or second frequency), wherein the transmission radiation is emitted along the transmission path 6 to the target 2 and at least some of the transmission radiation is reflected back from the target 2 to the interferometer 30. The returning parts of the transmission radiation have the reference radiation superimposed thereon, said reference radiation having passed over the reference path 5, as result of which a beat signal with a beat frequency (reception frequency, IFM frequency) is produced, which can be captured by an interferometer detector 7. By way of a continuous capture of the beat frequency, it is possible to capture a time resolved beat profile, for example.

On the basis of the beat profile of the beat frequency and the carrier frequency of the modulator, it is possible to derive the distance to the target by summing discrete values of a wavelength increment, wherein the wavelength increment is substantially given as an integer multiple of half the wavelength of the transmission radiation.

Further, the direction for the change in the distance can be derived, for example, on the basis of the time profile of the beat, frequency using the Doppler Effect. By way of example—in a simple case as in the described interferometer construction—the beat frequency at a constant distance to the target 2 substantially corresponds to precisely the difference frequency between the transmission radiation and the reference radiation, wherein the difference frequency corresponds to the carrier frequency of the employed acousto-optic modulator 8. In the case of a uniform movement of the target 2 over a predetermined period of time, the beat frequency experiences a direction-dependent frequency offset. If the distance decreases, the beat frequency is greater than the difference frequency, whereas the beat frequency is less than the difference frequency in the case of an increasing distance.

Within the scope of ascertaining the distance to the target 2, the beat frequency (IFM frequency) is captured by the reception counts of a reception counter and the carrier frequency is captured by reference counts of a reference counter, in particular by means of Johnson counters, wherein the reception counts and the reference counts are transferred into a common counting system of a system counting system by means of a synchronization member on the basis of a system clock with a system frequency, wherein the system frequency according to the invention differs from the carrier frequency and the derivation of the change in distance is effectuated taking account of a counter history of the system counting system over a count range defined by a plurality of clock pulses of the system counting system.

FIG. 3 schematically shows an embodiment according to the invention of a derivation of a change in distance to a target on the basis of a heterodyne interferometer arrangement 30 (FIG. 2), for example having a frequency shifter 8 in the transmission path 6 and an interferometer detector 7 for capturing and providing the interferometer output signal with an interferometer output frequency, referred to as IFM frequency) on the basis of a beat with a beat frequency (IFM frequency) that is generated by superimposing the reference signal on the returning parts of the transmission signal.

A system clock 10 serves as a basis for the data processing, wherein the carrier frequency and the IFM frequency are each captured by a reference counter 11 and a reception counter 12, respectively, which are decoupled from the system clock 10. According to the invention, care is moreover taken to ensure that the system clock 10 and the reference clock 13 of the reference counter 11 are different, and that the system clock 10 and the reception clock 14 of the reception counter 12 are different.

By means of a synchronization member and on the basis of the clock pulse 15 of the system clock 10, the counts of the reference counter 11 and of the reception counter 12 are respectively transferred into registers 16A,B of a common counting system (system counting system) defined by the system clock 10. A reception difference is produced by means of a storage and subtraction unit 17A,B for the reception channel 17A and the reference channel 17B by subtracting a receiver count from a preceding, e.g. immediately preceding, receiver count, and a reference difference is produced by subtracting a reference count from a preceding, e.g. immediately preceding, reference count. A summand is produced by means of a further storage and subtraction unit 18 by subtracting a reception difference from a reference difference. By way of example, the summand is supplied to a summing member 19 with each system clock pulse 15, the values of said summing member being supplied to an integrator 20, once again on the basis of the system clock pulse 15. After a corresponding integration over a defined number of clock pulses, for example periodically as a function of a defined number of clock pulses or in a moving fashion, the value of the integrator 20 is written into a readout register 21, wherein the derivation of the change in distance is effectuated taking account of the integration value in the readout register 21.

FIG. 4 schematically shows an embodiment of a circuit according to the invention with a system clock 10 as a basis for the evaluation, wherein, in this case, the carrier frequency 13 and the IFM frequency 14, for example, are respectively captured by Johnson counters 40A,B—e.g. 4-bit Johnson counters—that are decoupled from the system clock 10. With the clock pulse 15 of the system clock 10, the counts of the reference counter 40B and of the reception counter 40A are respectively transferred by means of a synchronization into a first register 41A,B—for example, a 4-bit register—and the preceding values of the first register 41A,B are respectively shifted into a further register 42A,B such that a reception difference 43A and a reference difference 43B are respectively produced by means of a subtraction member 43A,B—for example, a 4-bit subtraction member—and a summand is produced by a further subtraction member 44—for example, 4-bit subtraction member.

The reception difference and the reference difference state the number of counts the two input frequencies have incremented their respective counter during the last system clock phase. Typically, the two input clocks 13, 14 are lower than the system clock 10, which is why the arising differences only assume values 1 and 0.

Here, the summands are added to a 32-bit summing member 45, for example, with the summands each being able to assume values of −1, 0, and 1. The summing member 45 thus obtains a snapshot of the interferometer distance in the number of half wavelengths since the start of the measurement.

Here, the summands are fed further via the summing member 45 to a 48-bit integrator 46, for example, wherein the carrier frequency 13 and the synchronization frequency 10 are further provided here in such a way that a repetition rate of the system is defined in such a way that the carrier signal is respectively sampled periodically at the same position again with the repetition rate of the system. By way of example, the carrier frequency corresponds to a factor of 31/52 of the system frequency (on the basis of a 32-bit summing member, 4-bit subtraction member and a 48-bit integrator), as a result of which the sampling of the carrier signal is effectuated at exactly the same location again after 52 clock pulses of the system clock 10.

The current value of the summing member 45 is added to the integrator 46 with each clock pulse 15 of the system clock 10 and a modulo counter 47 is increased by one. Once the modulo counter 47 reaches its modulo value, which corresponds to the repetition rate of the exemplary system, 52 in this case, the value of the integrator 46 is written into a readout register 48—a 48-bit register in this case—and the content of the integrator 46 is deleted. The content of the readout register 48 thus contains modulo-times the actual distance value as a function of the wavelength increment.

Alternatively, it is also possible to form a moving mean over n-times the modulo value such that a new result is available with each clock pulse 15 of the system clock 10.

It is understood that these illustrated figures only schematically represent possible exemplary embodiments. The various approaches can likewise be combined with one another and with methods from the prior art.

1-14. (canceled)

15. A method for determining a change in the distance to a retroreflective target by means of interferometry, the method comprises:
producing radiation at a defined frequency, wherein at least some of the radiation is used as reference radiation and at least some of the radiation is emitted toward the target as measurement radiation;
shifting the frequency of some of at least one of the measurement radiation, the reference radiation and a reception radiation, which is based at least on some of the measurement radiation returning from the target, wherein the frequency shift is produced by means of a frequency shifter, actuated by a carrier signal, wherein the carrier signal has a carrier frequency;
capturing a superposition signal on the basis of at least some of the reception radiation and the reference radiation;
producing an interferometer output signal with an interferometer output frequency (referred to as an “IFM frequency”), on the basis of the superposition signal; and
deriving a change in distance on the basis of the IFM frequency and the carrier frequency on the basis of discrete positive and negative values of a wavelength increment which is substantially provided as an integer multiple of half the wavelength of the measurement radiation,
wherein, for the purposes of deriving the change in distance:
the IFM frequency is captured by reception counts of a reception counter,
the carrier frequency is captured by reference counts of a reference counter, and
the reception counts and the reference counts are transferred by means of a synchronization member based on a system clock with a system frequency into a common system counting system such that a current change in distance to the target is derived on the basis of system counts of the system counting system,
wherein the system frequency differs from the carrier frequency by a defined difference frequency, and
wherein the change in distance is derived taking account of a counter profile of the system counting system over a count range defined over a plurality of clock pulses of the system counting system.

16. The method according to claim 15, wherein the reference counter, the reception counter, the system counting system, and the synchronization member are configured such that the count range is defined as a periodic count range, namely in such a way that the carrier signal is respectively sampled periodically at the same point again with a number of clock pulses of the count range.

17. The method according to claim 15, wherein the change in distance is derived periodically with a period equal to the number of clock pulses of the count range, or the change in distance is derived in a moving fashion.

18. The method according to claim 15, wherein an integration of the counter profile of the system counting system is effectuated by means of an integration process that is automated over several clock pulses of the system counting system, wherein the integration process includes the following steps:
producing a reception difference by forming the difference between two reception counts, in particular between two reception counts immediately in succession,
producing a reference difference by forming the difference between two reference counts, in particular between two reference counts immediately in succession,
producing a summand for the addition in a summing member, wherein the summand is produced by forming a difference between the reception difference and the reference difference, and
integrating the counter profile by means of an integrator on the basis of the summand.

18. The method according to claim 15, wherein the carrier signal has a defined jitter of the carrier frequency or in that a defined jitter of the system frequency is produced.

19. The method according to claim 15, wherein the system frequency is greater than 50 MHz.

20. The method according to claim 15, wherein the reception counter or the reference counter are based on a Gray code counter.

21. A measuring appliance for determining the change in distance to a retroreflective target by means of interferometry, the measuring appliance comprising:
a radiation source producing radiation with a defined wavelength;
a reference channel and a measurement channel which are configured such that at least some of the radiation produced by the radiation source are used as a reference radiation via the reference channel and at least some of the radiation produced by the radiation source are emitted as a measurement radiation to the target via the measurement channel;
a frequency shifter that is actuatable by a carrier signal which is configured to produce a frequency shift of part of at least one of the measurement radiation, the reference radiation and a reception radiation based at least in part on the measurement radiation returning from the target on the basis of the carrier frequency of the carrier signal;
a receiver configured to:
capture a superposition signal on the basis of at least some of the reception radiation and the reference radiation, and
provide an interferometer output signal with an interferometer output frequency (referred to as an “IFM frequency”), on the basis of the superposition signal,
a circuit having:
a reception counter configured to capture the IFM frequency by reception counts,
a reference counter configured to capture the carrier frequency by reference counts,
a system counting system based on a system clock having a system frequency configured to provide a common counting system, and
a synchronization member configured to transfer the reception counts and the reference counts into the system counting system; and
a computing unit configured to derive the change in distance on the basis of the IFM frequency and the carrier frequency to be precise on the basis of discrete positive and negative values of a wavelength increment which is substantially provided as an integer multiple of half the wavelength of the measurement radiation, wherein a current change in distance to the target is derived on the basis of system counts of the system counting system,
wherein the measuring appliance is configured such that:
the system frequency differs from the carrier frequency by a defined difference frequency and
a counter profile of the system counting system is provided over a count range that is defined over several clock pulses of the system counting system, and
wherein the computing unit is configured such that the derivation of the change in distance is carried out taking account of the counter profile.

22. The measuring appliance according to claim 21, wherein the reference counter, the reception counter, the system counting system and the synchronization member are configured in such a way that the count range is defined as a periodic count range, namely in such a way that the carrier signal is respectively sampled periodically at the same point again with a number of clock pulses of the count range.

23. The measuring appliance according to claim 21, wherein the circuit and the computing unit are configured such that:
the change in distance is derived periodically with a period equal to the number of clock pulses of the count range, or
the change in distance is derived in a moving manner.

24. The measuring appliance according to claim 21, wherein the circuit has an integrator configured such that an integration of the count profile of the system counting system is effectuated by means of an integration process that is automated over several clock pulses of the system counting system, wherein the integration process includes the following steps:
producing a reception difference by forming the difference between two reception counts,
producing a reference difference by forming the difference between two reference counts,
producing a summand for the addition in a summing member, wherein the summand is produced by forming a difference between the reception difference and the reference difference, and
integrating the counter profile by means of the integrator on the basis of the summand.

25. The measuring appliance according to claim 21, wherein the carrier signal is configured such that the carrier signal has a defined jitter of the carrier frequency or the circuit is configured such that a defined jitter of the system frequency is produced.

26. The measuring appliance according to claim 21, wherein the circuit is configured such that the system frequency is greater than 50 MHz.

27. The measuring appliance according to claim 21, wherein the reception counter or the reference counter are based on a Gray code counter.
